(19) United States
(12) Patent Application Publication
(10) Pub. No.: US 2011/0041943 A1
(43) Pub. Date: Feb. 24, 2011

(54) TRANSFER HOSE WITH MULTIPLE LAY LINES

(75) Inventor: Melinda Donnelly, Sunderland (CA)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Flexmaster Canada Ltd., Richmond Hill, ON (CA)

(21) Appl. No.: 12/546,462

(22) Filed: Aug. 24, 2009

(51) Int. Cl. F16L 11/00

(52) U.S. Cl. 138/137

(57) ABSTRACT

A transfer hose with two or more lay lines located on the exterior layer of the transfer hose. The lay lines run longitudinally down the length of the hose and are preferably placed at various points along various axes, spread around the outer circumference of the transfer hose. Each lay line may or may not be equidistant from the next lay line. The lay lines include the ability to be marked with a date and/or time of placement in the current position, to allow for the hose to be laid straight and then rotated from one lay line to the next lay line. Rotation of the hose occurs after a predetermined amount of time has passed. The consistent rotation prevents one area of the interior of the hose from breaking down or wearing out from the abrasive slurry being carried inside before any other portion of the hose. The method of rotation allows the entire length and circumference of the hose to be used equally. This method and process of incremental rotation extends the life of the hose life.

### TECHNICAL FIELD

The present invention relates to transfer hoses and more particularly, relates to a transfer hose with a series of two or more external lay lines that are manufactured onto or into the external layer of the transfer hose.

### BACKGROUND INFORMATION

Hoses are currently used to transfer or transport fluid material from one place to another. In the aggregate industry, flexible transfer hosing is used to transport abrasive slurry material such as concrete, aggregate or mining materials. Although the flexible transfer hose is a necessity for this process, the interaction between the abrasive slurry material and the interior lining of the hose causes considerable wear and tear on the interior side of the hose in a region that the slurry rubs against while flowing through the hose. This wear region, however, is typically only a fraction (25% or so) of the entire interior circumference of the hose. As a result, the hose breaks down from the inside due to wear in that one region and must be replaced frequently, even though a significant portion of the hose is not worn down. The replacement of these hoses consumes time and costs considerable amounts of money.

Some traditional transfer hoses include a single lay line. The single lay line on the hose extends longitudinally along the entire length of the hose in order to provide a visual indication of any twisting of the hose between connections or hydraulic accessories. The single lay line has been used to ensure that the hose is placed in a straight arrangement without twisting. The single lay line assists a user in identifying twists or angles in the placement of the hose, but does not offer any protection against the wear and tear that occurs on a hose line. In fact, the single lay line actually acts to encourage increased wear and tear on one interior portion of the hose as the lay line encourages the user to place the hose with the lay line in the upward or other easily seen position, and to remain or keep the hose in that one position.

Accordingly, the slurry hose industry needs a transfer hose having an increased hose life while not adding to the cost of manufacture and site use of the hose.

### SUMMARY

In one embodiment of the present invention, the hose features two or more lay lines that are manufactured into the cover or exterior layer of the hose and which run longitudinally down the length of the hose. There will be at least two lay lines, but there could also be three, four, six or eight lay lines. In the preferred embodiment of the present invention, there are four lay lines. The four lay lines are preferably placed at various points along the circumference of the transport hose. The plurality of lay lines allow for the hose to be rotated to the next lay line after a predetermined amount of time has passed. The rotation to the next lay line will keep one area of the interior of the hose from breaking down before any other portion of the hose. This allows the entire length and circumference of the hose to be used equally. This method and process of incremental rotation extends the length of the hose life considerably over the prior art.

In a second embodiment of the present invention, the hose for the transport of materials and liquids comprises a generally circular transfer hose having a length, an interior region and an exterior region, the generally circular exterior region having a predetermined circumference. Two or more lay lines are positioned along the length of the hose on the exterior region, each of the two or more lay lines are disposed along a predetermined axis about the circumference of the exterior region of the hose.

The transport hose according to the present invention is designed to carry aggregate, concrete, slurry or another abrasive material that is dry or suspended in liquid. Each of the two or more lay lines typically include at least one region configured for accepting a marking of information such as a date, time, or other use indicator. In one embodiment of the present invention, the hose has four lay lines that are disposed around the circumference of the hose at 0 degrees, 90 degrees, 180 degrees and 270 degrees. Each of the two or more lay lines may be a different color. Each of the two or more lay lines may include a different pattern.

A method is disclosed that extends the useful life of a hose. This method comprises the acts of providing a generally circular transport hose having a length, an interior region and an exterior region. The generally circular exterior region has a predetermined circumference. Two or more lay lines are positioned along the length of the hose on the exterior region, each of the two or more lay lines are disposed along a predetermined axis about the circumference of the exterior region of the hose. The hose is positioned with a first of the two or more lay lines in a predetermined orientation. After a predetermined amount of time has elapsed, the hose is rotated a predetermined amount so as to position the hose with a second of the two or more lay lines in the predetermined orientation.

In a further embodiment of the present invention, the hose has four lay lines that are disposed on the exterior region of the hose at 0 degrees, 90 degrees, 180 degrees and 270 degrees. In another embodiment of the present invention, each of the two or more lay lines include at least one region configured for accepting a marking of a date, time, or other use indicator. The marking may be a date.

### BRIEF DESCRIPTION OF THE DRAWINGS

These and other features and advantages of the present invention will be better understood by reading the following detailed description, taken together with the drawings wherein:

FIG. 1 is perspective view of a transfer hose with a plurality of lay lines of the present invention;

FIG. 2 a close-up view of a flattened exterior portion of the transfer hose showing one embodiment of the present invention with four lay lines;

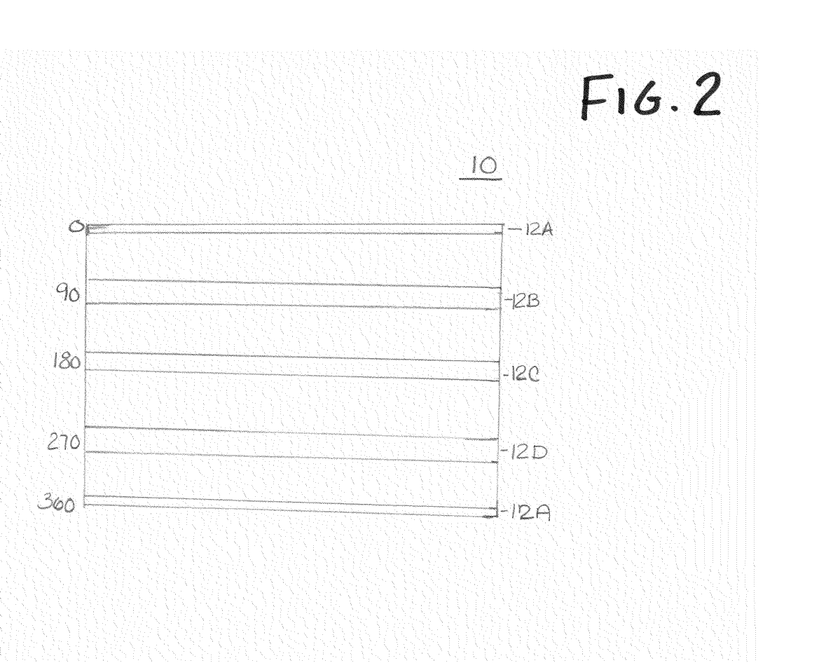

FIGS. 3A and 3B show a detailed and an exploded view of the marking located on the lay lines of the transfer hose of the present invention; and

FIGS. 4A, 4B and 4C are perspective views of the transfer hose showing the lay lines in various configurations of multiple embodiments of the present invention.

### DETAILED DESCRIPTION OF THE PREFERRED EMBODIMENTS

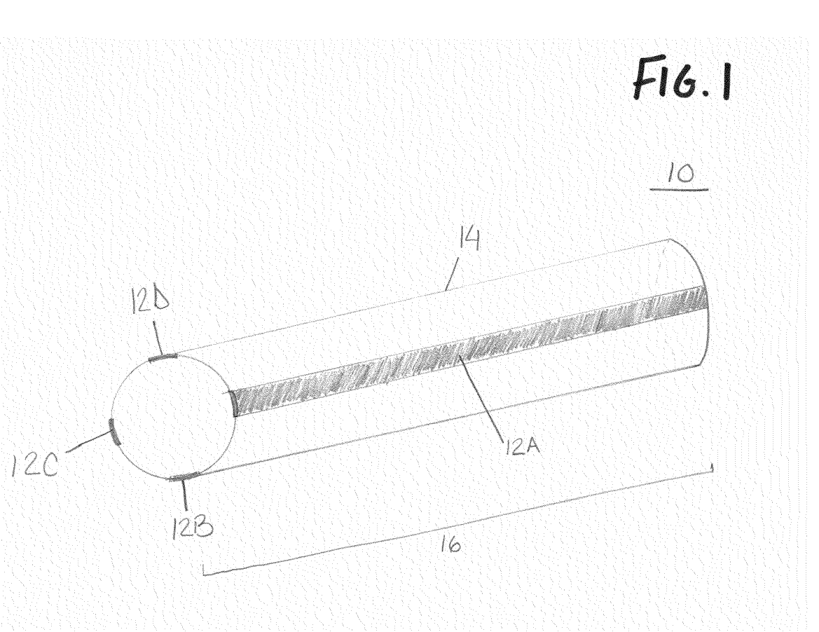

The transfer hose 10 is shown in FIG. 1 in a preferred embodiment of the present invention. The transfer hose is made from typical transfer hose materials such as rubber or thermoplastic compounds, reinforced or non-reinforced with fabric and helix wire. The transfer hose may have a circumference ranging from 1 inch to 36 inches in diameter. The transfer hose 10 is designed to carry mining materials, aggregate, concrete, slurry and other materials (not shown).

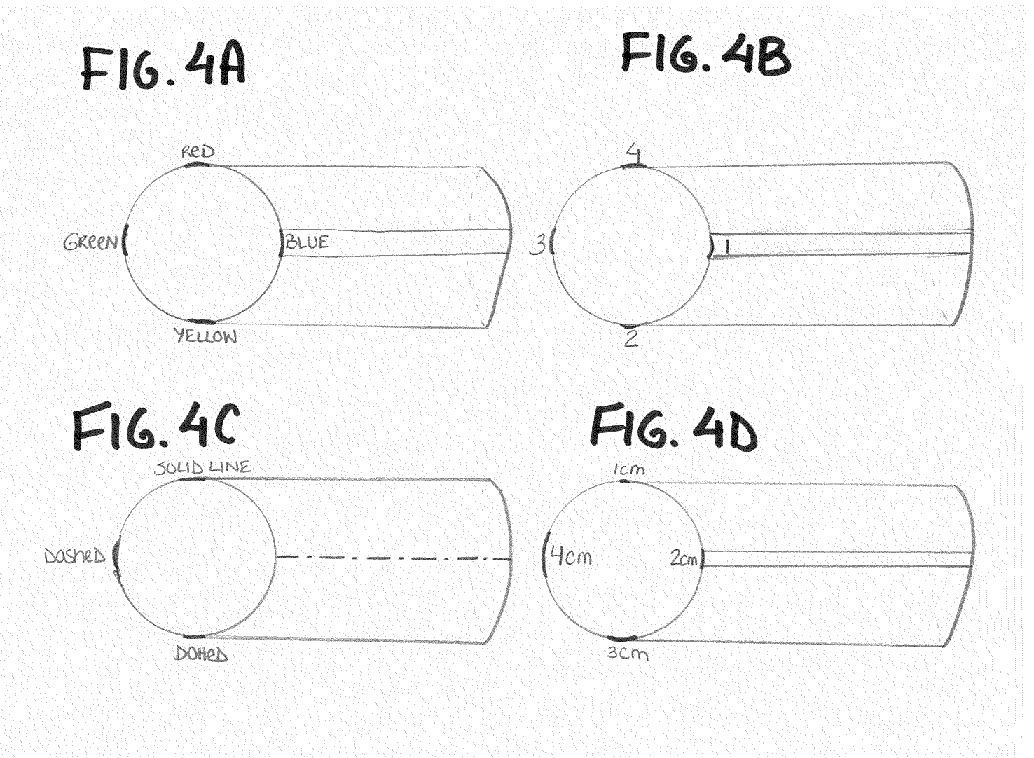

The transfer hose 10 includes a plurality of lay lines 12. The lay lines are located on the exterior cover portion of the transfer hose 10. The lay lines are applied or manufactured into the lay line by one or more well known methods such as by painting on the surface of the exterior layer of the hose, extrusion into the outer layer of the hose, or incorporation of steam cured lay line tape that is affixed to the hose, or other process. The lay lines 12 are typically of a different color than the color of the exterior cover transfer hose 10 and each lay line 12 may itself be a different color (FIG. 4A). Additionally, each lay line may have any number of different markings, such as numbering (FIG. 4B), various dash marks and lengths (FIG. 4C), or different thicknesses, such as 1 cm in diameter, 2 cm in diameter, etc. (FIG. 4D). The variations will assist a user in differentiating between the multiple lay lines.

Each external lay line 12 is used as an indicator or marker of the installation position upon first use and subsequent rotation and use over time. The lay lines are used and marked upon installation and oriented to a fixed point in space (i.e. in the up position) or oriented to any piece of industrial equipment including, for example a debris vacuum truck, a hose support trolley, etc. Depending on the application and frequency of use, the hose is then rotated after a predetermined period of time (i.e. each week, month, quarter, year, etc) which time depends on the type and amount of slurry being carried by the hose to line up with the next lay line. The hose can be rotated clockwise or counterclockwise. The rotation can occur after a specified amount of use or after a specified amount of time. The frequency of rotation may vary depending on the materials being transported and on other relevant factors such as. The specified amount of time or the actual time and date can be put onto the lay line as a marking using a permanent marker or some other marking tool or procedure. The purpose of the marking and the rotation is to delineate the amount of time the hose has been in use in a certain position. Using the lay lines in combination with rotation serves to extend the life of the hose by ensuring that the hose is not replaced prematurely, until all interior sides of the hose have been used.

In the preferred embodiment of the present invention, the transfer hose 10 is equipped with four lay lines 12a-12d. The lay lines are positioned on or within the external or outer cover 14 of the transfer hose 10 and are spaced at various predetermined longitudinal axes of approximately 90 degrees around the outer cover 14 of the transfer hose 10. Each lay line 12 runs along the entire length 16 of the transfer hose 10. The lay lines serve as a marker or visual indicator of the initial and subsequent installation position. Depending on the frequency and use of the hose and of the type of slurry material being carried, the hose can then be rotated periodically or at pre-determined intervals, to the next lay line 12.

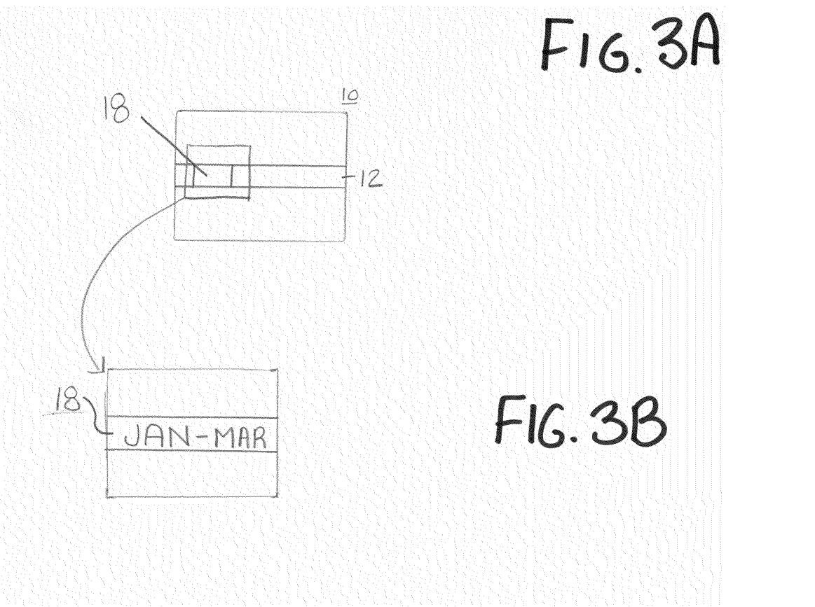

Additionally, the lay line will be adapted for receiving a marking on the exterior of the lay line, as shown in FIGS. 3A and 3B. The marking 18 may be a time, a date, or another indicator of use. A user of the hose may write with a permanent marker, stamp or other writing implement the preferred information in the form of a marking 18 onto the lay line 12 that is oriented at the uppermost or other desired position of the transfer hose 10. After a specified amount of time or use, the transfer hose 10 will be rotated. The next lay line 12 will be rotated to the uppermost (or other desired) position and will be marked with a new date of installation. This deliberate and marked rotation of the hose prevents the interior and exterior of the hose from wearing out in certain overused positions when it is used to carry heavy and abrasive materials. This rotation will continue until the rotation brings the user back to the first lay line that was originally used. At this point, the process will begin again or the hose will be replaced.

In the preferred embodiment of the current invention the hose will have four lay lines. These lay lines will be disposed at 0 or 360 degrees (12a), 90 degrees (12b), 180 degrees (12c) and 270 degrees (12d). A first placement of the hose will utilize the lay line at 0 degrees (12a). The commencement of this placement will be marked on the 0 degrees lay line (12a) with the date of first use and possibly a time of first use. This lay line will be utilized for a specified amount of time. After the specified amount of time has passed, the hose will then be rotated 90 degrees and the new date and possibly time will be marked on the 90 degree lay line (12b). The second lay line of 90 degrees will then be used for another specified amount of time. This process will continue, using the 180 degree lay line (12c) and then the 270 degree lay line (12d). After each of the four lay lines have been used for a specified amount of time, the user will know that the hose 10 must be replaced and a new hose will be installed and the process will repeat itself. This rotation process will continue, using each 90 degree portion of the hose, in an equal manner such that no portion of the hose wears out prematurely. This process allows the hose to last for a longer period of time without one portion of the hose being overused and leading to failure of the entire hose. This method utilizes less hose, is less expensive, and saves time spent on repairing and replacing hoses.

In another embodiment of the present invention, the transfer hose 10 may have only two lay lines 12, located at 0 or 360 degrees and at 180 degree. In a further embodiment of the present invention, the transfer hose 10 may have three or more lay lines 12. The lay lines 12 will preferably be located at equal distances around the circumference of the transfer hose 10, to facilitate even distribution of the use of the hose.

The present invention is not intended to be limited to a device or method which must satisfy one or more of any stated or implied objects or features of the invention and should not be limited to the preferred, exemplary, or primary embodiment(s) described herein. Modifications and substitutions by one of ordinary skill in the art are considered to be within the scope of the present invention, which is not to be limited except by the allowed claims and their legal equivalents.

The invention claimed is:

1. A hose for the transport of materials or liquids, comprising:
a generally circular transfer hose having a length, an interior region and an exterior region, said generally circular exterior region having a predetermined circumference; and
two or more lay lines positioned along said length of the hose on said exterior region, each of said two or more lay lines disposed along a predetermined axis about said circumference of said exterior region of said hose.

2. The hose of claim 1, wherein the hose is designed to carry aggregate, concrete, slurry or another abrasive material that is dry or suspended in liquid.

3. The hose of claim 1, wherein each of the two or more lay lines include at least one region configured for accepting a marking of a date, time, or other use indicator.

4. The hose of claim 1, wherein the hose has four lay lines that are disposed around the circumference of the hose at 0 degrees, 90 degrees, 180 degrees and 270 degrees.

5. The hose of claim 1, wherein each of the two or more lay lines is a different color.

6. The hose of claim 1, wherein each of the two or more lay lines includes a different pattern.

7. A method of extending the useful life of a hose, comprising the acts of:
providing a generally circular transfer hose having a length, an interior region and an exterior region, said generally circular exterior region having a predetermined circumference; and two or more lay lines positioned along said length of the hose on said exterior region, each of said two or more lay lines disposed along a predetermined axis about said circumference of said exterior region of said hose;
positioning the hose with a first of said two or more lay lines in a predetermined orientation; and
after a predetermined amount of time has elapsed, rotating the hose a predetermined amount so as to position the hose with a second of said two or more lay lines in said predetermined orientation.

8. The method of claim 7 wherein the hose has four lay lines that are disposed on the exterior region of said hose at 0 degrees, 90 degrees, 180 degrees and 270 degrees.

9. The method of claim 7 wherein each of the two or more lay lines include at least one region configured for accepting a marking of a date, time, or other use indicator.

10. The method of claim 9 wherein the marking is a date.
